(19) United States
(12) Patent Application Publication
(10) Pub. No.: US 2008/0100691 A1
(43) Pub. Date: May 1, 2008

(54) FREQUENCY MODULATOR

(75) Inventor: Fumitaka Sobue, Abiko-shi (JP)

Correspondence Address: ROSSI, KIMMS & McDOWELL LLP., P.O. BOX 826, ASHBURN, VA, 20146-0826, US

(73) Assignee: CANON KABUSHIKI KAISHA, Tokyo (JP)

(21) Appl. No.: 11/870,323

(22) Filed: Oct. 10, 2007

(30) Foreign Application Priority Data
Oct. 13, 2006 (JP) 2006-280146

(51) Int. Cl. B41J 2/435

(52) U.S. Cl. 347/247

(57) ABSTRACT

A frequency modulator which employs a method in which the frequency of an image clock is modulated by a predetermined amount of fluctuation to thereby reduce noise, and is capable of providing images free from color shift caused by frequency modulation. A frequency controller of the frequency modulator generates frequency-modulated image clocks associated with images formed by respective lasers, and the frequency change profiles of the respective frequency-modulated image clocks are controlled such that they are identical with respect to the positions of the images formed by the respective lasers.

### BACKGROUND OF THE INVENTION

1. Field of the Invention

The present invention relates to a frequency modulator configured to generate an image clock for use in ON/OFF control of a laser beam that scans the surface of an image carrier, such as a photosensitive drum.

2. Description of the Related Art

In general, an electrophotographic image forming apparatus scans a laser beam emitted from a semiconductor laser using a rotary polygon mirror to illuminate a photosensitive member, while repeatedly turning on and off the laser beam, whereby an electrostatic latent image is formed on the photosensitive member.

Generally, in an image forming apparatus of the above-mentioned type, an image clock of a fixed frequency is used for ON/OFF control of the laser beam. This is because unless the frequency of the image clock is fixed, ON/OFF timing of the laser beam deviates from normal timing, which causes slight displacement of positions of dots of an electrostatic latent image formed on the photosensitive member and resultant image distortion, color shift, or color irregularity.

Further, the image forming apparatus has an f-θ lens disposed between the polygon mirror and the photosensitive member. The f-θ lens has optical properties for condensing a laser beam and performing distortion aberration correction ensuring temporal linearity of scanning, whereby the laser beam passed through the f-θ lens is scanned on the photosensitive member for image formation in a predetermined direction at a constant speed.

However, a deviation of the characteristic of this f-θ lens can cause a deviation of the laser beam irradiated onto the photosensitive member from an ideal image-forming position. To prevent this, a frequency modulation technique is employed in which the frequency of a reference image clock is modulated so as to finely adjust the ON/OFF timing of the laser beam, thereby correcting the positions of respective dots formed on the photosensitive member (see Japanese Laid-Open Patent Publication (Kokai) No. H02-282763).

However, when the image clock is always fixed, radiation noise is generated in a transmission path along which an ON/OFF signal for controlling the ON/OFF timing of the laser beam is transmitted from an ON/OFF signal generating circuit to a laser drive circuit. The level of the radiation noise often exceeds a value specified in the international radiation noise standard.

Further, while the use of the frequency modulation technique lowers the radiation noise level, if a f-θ lens having such a characteristic as makes it unnecessary to perform frequency modulation is used, the frequency of the image clock is constant, which makes the radiation noise level higher.

In a tandem-type color image forming apparatus or the like which suffers a color shift in the main scanning direction, frequency modulation is often used to correct the characteristic of the f-θ lens. On the other hand, a single-drum color image forming apparatus which cares little about color shift in the main scanning direction or a monochrome image forming apparatus which need not care about color shift rarely performs frequency modulation. In such a case as well, the level of radiation noise often exceeds the value specified in the international radiation noise standard.

To lower the level of noise caused by an image clock, there has been proposed a technique of changing the frequency of the image clock by a predetermined amount of fluctuation to thereby lower the peak level of radiation noise in a specific frequency band (see Japanese Laid-Open Patent Publication (Kokai) No. 2004-268504).

FIG. 5A is a diagram useful in explaining a case where image clock modulation (frequency modulation) is applied to a laser scanner unit based on a multi-beam method. Generally, in the case of the multi-beam method, a laser chip is tilted, as shown in FIG. 5C, such that a laser beam spot interval on a drum surface becomes equal to a sub scanning pitch determined according to resolution.

In this case, since the relative positions of respective lasers A and B in the main scanning direction are different from each other, writing by the laser A and writing by the laser B are started with a time shift corresponding to a positional difference in the main scanning direction between the two lasers A and B. In this case, if the modulation of the laser A and that of the laser B are each started upon the lapse of the same time period with reference to a BD (Beam Detect) signal, the amount of deviation from an ideal position due to frequency modulation becomes different between the laser A and the laser B. This causes positional deviation of dots between the laser A and the laser B, which adversely affects an image.

Further, when frequency modulations different in the period and amplitude thereof depending on an image position are performed in association with the respective lasers, the amount of deviation from an ideal position becomes different between the lasers, which causes positional deviation of dots.

Similarly, in the case of the tandem-type image forming apparatus, color shift occurs, as shown in FIGS. 12A to 12C, for the same reason as described above, which adversely affects an image.

### SUMMARY OF THE INVENTION

The present invention provides a frequency modulator which employs a method in which the frequency of an image clock is modulated by a predetermined amount of fluctuation to thereby reduce noise, and is capable of providing images free from color shift caused by frequency modulation.

In a first aspect of the present invention, there is provided a frequency modulator for frequency-modulating an image clock, comprising a modulated image clock-generating unit configured to generate frequency-modulated image clocks, and a frequency change profile control unit configured to control frequency change profiles of the respective frequency-modulated image clocks such that the frequency change profiles become identical with respect to positions of associated images formed by respective lasers.

According to the present invention, even if the method in which the frequency of an image clock is modulated by a predetermined amount of fluctuation to thereby reduce noise is employed, it is possible to provide images free from color shift caused by frequency modulation.

In a second aspect of the present invention, there is provided a frequency modulator configured to generate image clocks having frequencies which are different between at least one portion and another portion of a main scanning line on an image carrier which is scanned by laser beams emitted from a plurality of semiconductor lasers, irrespective of a magnification of an image, comprising a modulation start timing-setting unit configured to set modulation start timing in which modulation of each image clock is to be started, a modulation period-setting unit configured to set a repetition period over which the image clock is modulated, a modulation amount-setting unit configured to set an amount of modulation by which the image clock is modulated from a reference period thereof, a modulated image clock-generating unit configured to generate a modulated image clock by modulating a frequency of each of the image clocks into a frequency set by the modulation start timing-setting unit, the modulation period-setting unit, and the modulation amount-setting unit, and a frequency change profile control unit configured to control frequency change profiles of the respective modulated image clocks such that the frequency change profiles become identical with respect to positions of associated images formed by respective lasers.

The modulation start timing which is set by the modulation start timing-setting unit can be defined by a count of the modulated image clock.

The modulation start timing which is set by the modulation start timing-setting unit can be controlled by modulating a repetition period of the modulated image clock in timings corresponding to an area outside an image area.

The modulation start timing which is set by the modulation start timing-setting unit can be controlled by changing output start timing of the modulated image clock in a main scanning direction.

The modulation period which is set by the modulation period-setting unit can be defined by a count of the modulated image clock.

The modulation amount which is set by the modulation amount-setting unit can be defined by a proportion with respect to a reference period of the image clock.

The features and advantages of the invention will become more apparent from the following detailed description taken in conjunction with the accompanying drawings.

### BRIEF DESCRIPTION OF THE DRAWINGS

FIG. 1 is a schematic view of an exposure unit of an image forming apparatus, according to a first embodiment of the present embodiment.

FIG. 2 is a block diagram of a frequency modulator according to the first embodiment, which is used to drivingly control a laser light source appearing in FIG. 1.

FIG. 3 is a block diagram showing the configuration of a frequency-modulating parameter appearing in FIG. 2.

FIG. 4 is a block diagram of a light-emitting signal generator unit appearing in FIG. 2.

FIGS. 5A to 5D are diagrams useful in explaining the relationship between the frequencies of image clocks generated by the frequency modulator in FIG. 2 and a main scanning position (first example).

FIGS. 6A to 6D are diagrams useful in explaining the relationship between the frequencies of the image clocks generated by the frequency modulator in FIG. 2 and the main scanning position (second example).

FIG. 7 is a diagram useful in explaining a case where timing for modulating an image clock from a fundamental period thereof is controlled by the frequency modulator in FIG. 2 by modulating an image clock period starting from an area outside an image area before start of image writing.

FIGS. 8A and 8B are diagrams useful in explaining a case where the frequency modulator in FIG. 2 is configured not to generate an image clock in timings in an area outside the image area before the image area is reached.

FIG. 9 is a schematic view of exposure units of an image forming apparatus, according to a second embodiment of the present embodiment.

FIG. 10 is a block diagram of a frequency modulator according to the second embodiment, which is used to drivingly control a laser light source appearing in FIG. 9.

FIG. 11 is a block diagram showing the configuration of a frequency-modulating parameter appearing in FIG. 10.

FIGS. 12A to 12C are diagrams and a view useful in explaining the relationship between the frequencies of image clocks generated by the frequency modulator in FIG. 10 and a main scanning position (first example).

FIGS. 13A and 13B are diagrams useful in explaining the relationship between the frequencies of the image clocks generated by the frequency modulator in FIG. 10 and the main scanning position (second example).

### DETAILED DESCRIPTION OF THE PREFERRED EMBODIMENTS

The present invention will now be described in detail below with reference to the drawings showing preferred embodiments thereof.

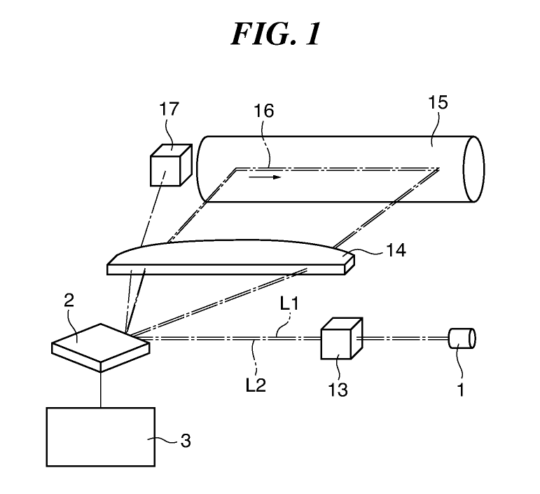

FIG. 1 is a schematic view of an exposure unit of an image forming apparatus, according to a first embodiment of the present embodiment

In the following, the arrangement of the exposure unit will be described together with the operation thereof.

As shown in FIG. 1, the electrophotographic image forming apparatus includes the exposure unit that irradiates a photosensitive drum 15 with laser beams so as to form a latent image corresponding to input image data on the photosensitive drum 15.

The exposure unit is provided with a laser light source 1 having two lasers A and B, not shown, as light-emitting points from each of which a spread laser beam is emitted. The laser beam emitted from the laser light source 1 is converted into parallel laser beams L1 and L2 by a collimator lens 13, and the laser beams L1 and L2 are irradiated onto a polygon mirror 2 which is being rotated by a scanner motor 3. Then, the laser beams L1 and L2 irradiated onto the polygon mirror 2 are reflected by the polygon mirror 2 to be guided to a f-θ lens 14.

The laser beams L1 and L2 having passed through the f-θ lens 14 are scanned on the photosensitive drum 15 for image formation in the main scanning direction at a constant speed. A latent image 16 is formed on the photosensitive drum 15 by the scanning operation of the laser beams. The start of the scanning operation of the laser beams is detected by a beam detect sensor (hereinafter referred to as “the BD sensor”) 17.

The laser light source 1 is forcibly turned on in a manner synchronous with the start of the scanning operation of the laser beams on the photosensitive drum 15. The BD sensor 17 detects the laser beam L1 reflected by the polygon mirror 2 and input through the same during a time period over which the laser light source 1 is forcibly kept on, and outputs a beam detect signal (hereinafter referred to as “the BD signal”) as a reference signal for timing in which image writing is started on each main scanning line.

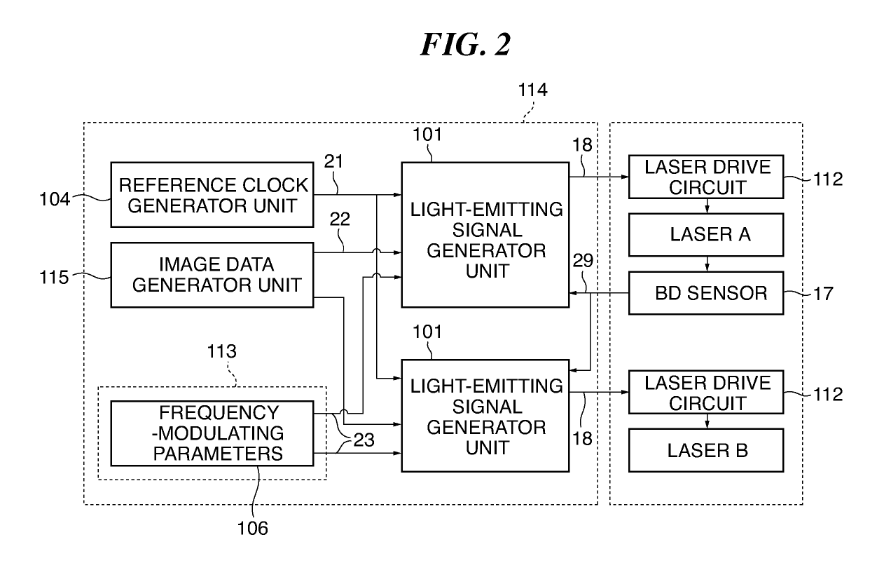

Next, the configuration of a frequency modulator for modulating frequencies of respective image clocks to be used to drivingly control the laser light source 1 will be described with reference to FIGS. 2 to 4.

FIG. 2 is a block diagram of the frequency modulator according to the first embodiment, which is used to drivingly control the laser light source 1 appearing in FIG. 1. In the following, the configuration of the frequency modulator will be described together with the operation thereof.

As shown in FIG. 2, the frequency modulator 114 for frequency-modulating the image clocks to be used to drivingly control the laser light source 1 is comprised of a reference clock generator unit 104 for generating a reference clock 21, a memory 113 for generating frequency-modulating parameter signals 23, an image data generator unit 115 for generating image data 22, and light-emitting signal generator units 101.

The memory 113 stores frequency-modulating parameters 106, and the frequency-modulating parameters 106 include various set values required for modulation of the image clocks by the frequency modulator 114.

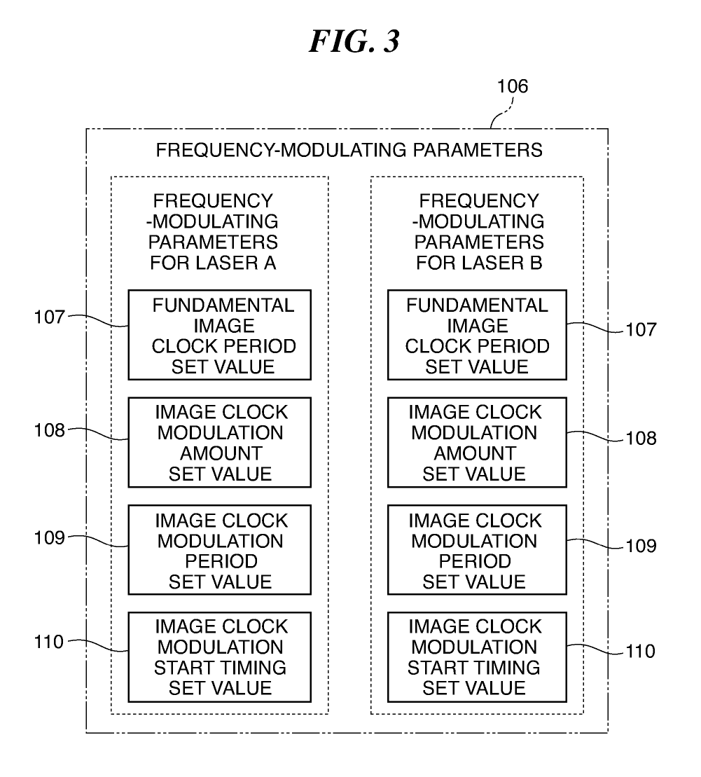

FIG. 3 is a block diagram showing the frequency-modulating parameters appearing in FIG. 2.

Specifically, as shown in FIG. 3, a fundamental image clock period set value 107 is stored in association with each of the lasers A and B as a set value corresponding to the fundamental period of an image clock generally determined based on the drum surface scanning speed of a laser and the resolution.

An image clock modulation amount set value 108 is stored in association with each of the lasers A and B as a set value corresponding to a maximum amount of extension/shortening of the period of an image clock from its fundamental period (i.e. a period fluctuation width).

An image clock modulation period set value 109 is stored in association with each of the lasers A and B as a set value for setting the number of pixels required for the image clock period to start to be modulated from the fundamental period, reach the maximum period and the minimum period, and then return to the fundamental period.

An image clock modulation start timing set value 110 is stored in association with each of the lasers A and B as a set value for setting timing for starting modulation according to the image clock modulation amount and the image clock modulation period after receiving the BD signal.

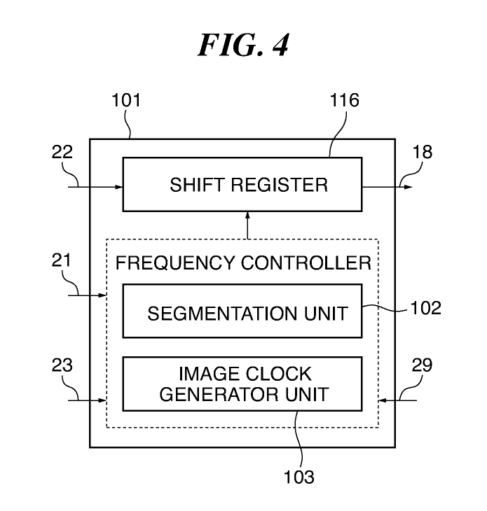

These set values are transferred to the light-emitting signal generator units 101 by the respective frequency-modulating parameter signals 23. As shown in FIG. 2, the image data generator unit 115 generates image data 22 as a signal for causing the laser light source 1 to turn on for image formation. One-line image data 22 corresponding to each of the lasers is delivered to an associated one of the light-emitting signal generator units 101. Each piece of the image data 22 is stored in a shift register 116 in the associated light-emitting signal generator unit 101, as shown in FIG. 4.

As shown in FIG. 4, the light-emitting signal generator unit 101 has a segmentation unit 102 and an image clock generator unit 103. These units 102 and 103 constitute a frequency controller.

The segmentation unit 102 divides one line to be scanned in the main scanning direction into a plurality of segments each constituted by a number of pixels determined based on the image clock modulation period set value 109.

The image clock generator unit 103 generates image clocks associated with the respective segments, based on the reference clock 21 generated by the reference clock generator unit 104. Specifically, image clocks each having its period modulated according to the associated image clock modulation amount set value 108 are generated with the respective associated fundamental image clock period set values 107 as fundamental periods.

Modulation of each image clock is started in timing set based on the associated image clock modulation start timing set value 110, and the modulated image clock is output to the associated shift register 116. The shift register 116 receives the image clock and sequentially outputs pulses of the light-emitting signal to an associated one of laser drive circuits 112 according to stored image data. The laser drive circuit 112 controls the light emission of the associated laser according to the input light-emitting signal 18. In FIGS. 2 and 4, reference numeral 29 designates the BD signal.

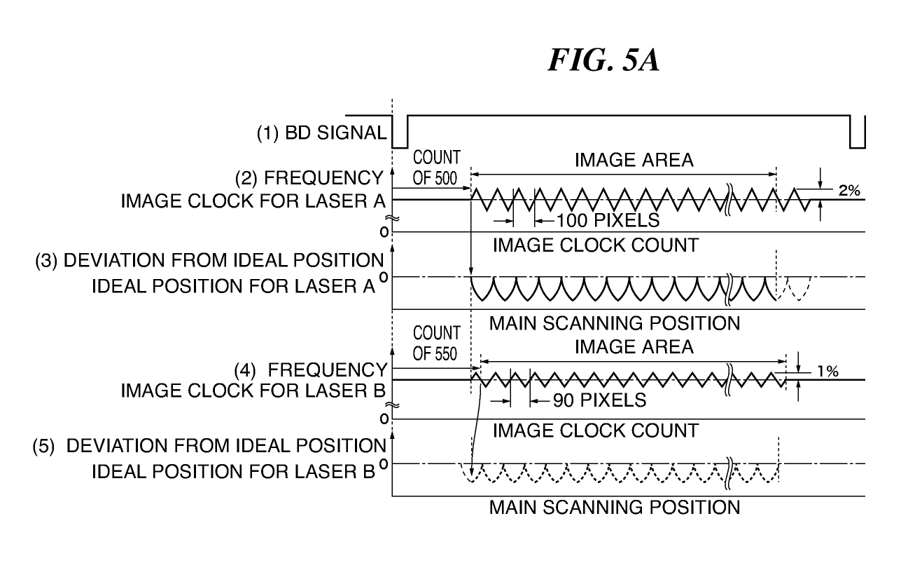

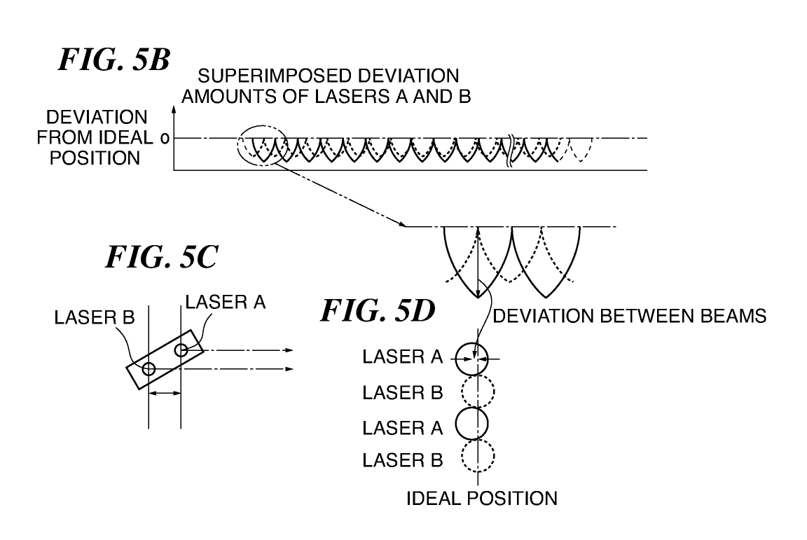

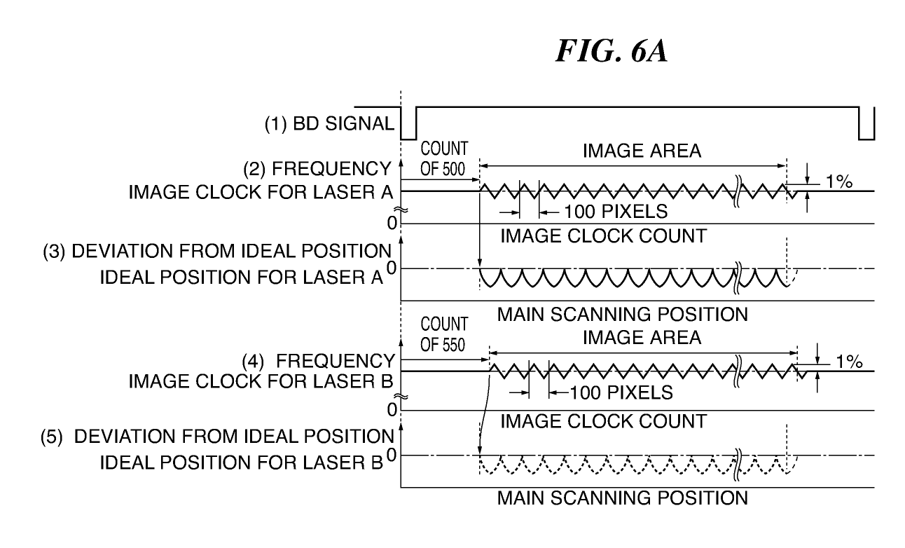

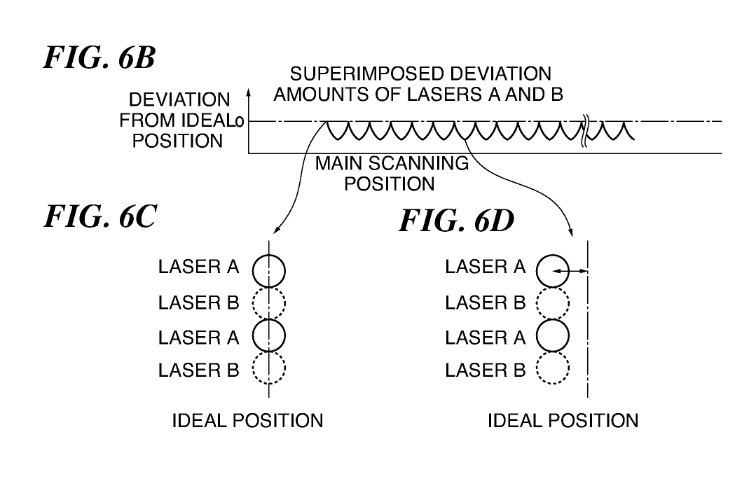

Next, image clock modulation realized by the above-described configuration for frequency modulation will be described with reference to FIGS. 5A to 6D. FIGS. 5A to 5D and 6A to 6D are diagrams useful in explaining the relationships between the frequencies of the respective image clocks generated by the frequency modulator shown in FIG. 2 and the main scanning position.

FIG. 5A is a diagram showing a case where the modulation period, the modulation amount, and the modulation start timing associated with the laser A and those associated with the laser B are modulated separately.

A part (1) of FIG. 5A shows the BD signal, and in the part (1), there is shown a time period from a time point of detection of a BD signal pulse to a time point of detection of a next BD signal pulse, i.e. timing for one scanning operation performed by a laser beam on the drum surface. A part (2) of FIG. 5A shows how the frequency of the image clock associated with the laser A changes during the single scanning operation. The vertical axis represents the frequency of the image clock, and the horizontal axis represents the count of the image clock pulses.

The part (1) of FIG. 5A shows that counting is performs using the same frequency until a count of 500 is reached after detection of the BD signal, and from a count of 501, counting is performed with a cycle (period) of 100 counts while changing the frequency by a fixed fluctuation amount of +2%. Image writing is started in timing synchronous with the count of 501.

A part (3) of FIG. 5A is a diagram showing the amount of deviation of each dot from an ideal position on the drum surface in a case where the laser is driven at the image clock frequency shown in the part (2) of FIG. 5A. The vertical axis represents the deviation amount, and the horizontal axis represents the main scanning position on the drum surface. Normally, an exposure unit of an image forming apparatus has an optical system thereof designed such that a laser beam scans the surface of a drum surface at a constant speed.

In the present embodiment as well, it is assumed that the optical system of the exposure unit is designed such that the laser beam scans the surface of the drum surface at a constant speed. In this case, when the frequency of an image clock is constant, intervals between dots become uniform. Image data for which the laser is driven is generated with equal dot intervals, so that when the frequency of the image clock is varied as in the present embodiment, each dot is formed at a location deviated from the ideal position.

This deviation amount is shown as “deviation amount from ideal position” in the part (3) of FIG. 5A. As the frequency is higher, the dot interval becomes smaller, and therefore the amount of deviation from the ideal position varies in a negative direction. On the contrary, as the frequency is smaller, the dot interval becomes larger, and therefore the amount of deviation from the ideal position varies in a positive direction. This relationship is shown in the parts (2) and (3) of FIG. 5A.

Similarly to the part (2) of FIG. 5A, a part (4) of FIG. 5A shows how the frequency of the image clock associated with the laser B changes. The frequency of the image clock starts to be changed in timing synchronous with a count of the 501, as in the case of the laser A. However, the leading end of an image corresponds to a count of 551. Differently from the modulation amount and modulation period associated with the laser A, the modulation amount associated with the laser B falls within a range of ±1%, and one modulation period associated with the laser B corresponds to 90 counts.

Similarly to the part (3) of FIG. 5A, a part (5) of FIG. 5A shows the amount of deviation of each dot formed by the laser B from the ideal position on the drum surface.

FIG. 5B is a diagram showing the part (3) of FIG. 5A and the part (5) of the same in a superimposed manner.

FIG. 5C is a view showing the positional relationship between the light-emitting point of the laser A and that of the laser B. As shown in FIG. 5C, in a multi-beam system, a sub scanning interval on the drum surface between the laser A and the laser B is generally adjusted by tilting a laser chip, so as to adjust the sub scanning interval according to the resolution of an image to be formed. This changes the relative positions of the respective lasers A and B in the main scanning direction according to the inclination angle of the laser chip.

By changing timings in which the lasers A and B start image writing to the timings shown in the respective parts (2) and (4) of FIG. 5A, according to the difference between the two main scanning positions, it is possible to cause the lasers A and B to start writing respective images at the same position on the drum surface.

However, when the lasers A and B are different in the modulation amount, the modulation period, and the image clock modulation timing as shown in the parts (2) and (4) of FIG. 5A, the amount of deviation from an ideal position varies between beams, depending on an image height, as shown in FIG. 5B. This causes deviation in the main scanning position, and hence a vertical line is drawn in a jagged manner, for example, as shown in FIG. 5D, which adversely affects the image.

FIGS. 6A to 6D are diagrams useful in explaining a case where the image clock modulation start timing is changed in accordance with the image writing start timing to thereby adjust the modulation period and the modulation amount between the lasers.

In FIG. 6A, the laser A and the laser B are both configured to have an image clock modulation period of 100 clocks and an image clock modulation amount of ±1%. Therefore, the difference in the modulation amount between adjacent pixels, i.e. a per-clock change rate of the modulation amount is 1%÷25 (clocks)=0.04%. The image writing start timing of the laser B is delayed by 50 clocks with respect to that of the laser A as described above, and hence if modulation is started in this state, a difference of 0.04%×50=2% in the maximum occurs in the modulation amount, which causes deviation in the main scanning position as described hereinbefore. To prevent this, the image clock modulation start timing associated with the laser B is delayed by the number of clocks corresponding to the number of the delayed clocks of the image writing start timing (i.e. delayed by 50 clocks in the present embodiment) so as to start modulation at the same phase. In this case, as shown in FIG. 6B, the amounts of deviation of images formed by each of the lasers A and B from the ideal position become equal to each other at each image height.

FIG. 6C shows the ideal position and dot positions in a case where the deviation amount is equal to 0, and FIG. 6C shows the ideal position and dot positions in a case where the deviation amount is equal to 1%. In FIG. 6D, the laser A and the laser B are both deviated from the ideal position, but since the deviation amounts are equal to each other at each image height in the main scanning direction, occurrence of deviation between dot positions associated with the respective lasers A and B can be prevented.

Further, in the present embodiment, the maximum amount of deviation from the ideal position corresponds to ±1.02 pixels, and the difference in dot size between adjacent pixels is equal to a small value of 0.0004 pixels, so that the deviation from the ideal position can hardly be sensed by the human eye.

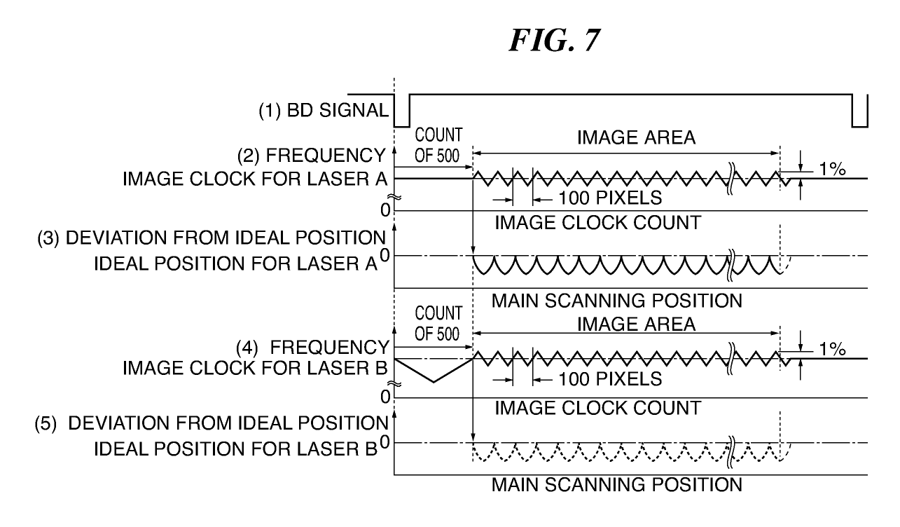

FIG. 7 is a diagram useful in explaining a case where timing for modulating an image clock from a fundamental period thereof is controlled by the frequency modulator in FIG. 2 by modulating an image clock period starting from an area outside an image area before start of image writing.

A part (1) of FIG. 7 shows the BD signal 29, and in the part (1), there is shown a time period from a time point of detection of a BD signal pulse to a time point of detection of a next BD signal pulse, i.e. timing for one scanning operation performed by a laser beam on the drum surface.

A part (2) of FIG. 7 shows how the frequency of the image clock associated with the laser A changes during the single scanning operation. The vertical axis represents the frequency of the image clock, and the horizontal axis represents the count of image clock pulses. The part (1) of FIG. 7 shows that counting is performs using the same frequency until a count of 500 is reached after detection of the BD signal, and from a count of 501, counting is performed with a cycle (period) of 100 counts while changing the frequency by a fixed fluctuation amount of ±2%. Image writing is started in timing synchronous with a count of 501.

A part (3) of FIG. 7 shows the amount of deviation of each dot from an ideal position on the drum surface in a case where the laser is driven at the image clock frequency shown in the part (2) of FIG. 7. The vertical axis represents the deviation amount, and the horizontal axis represents the main scanning position on the drum surface.

Similarly to the part (2) of FIG. 7, a part (4) of FIG. 7 shows how the frequency of the image clock associated with the laser B changes. Similarly to the case of the laser A, the frequency of the image clock starts to be changed in timing synchronous with a count of 501. However, the image clock associated with the laser B is set such that the frequency thereof changes at a low level over a time period until the 500-th clock, whereby this time period is made equal to a time period over which 550 clocks are counted without changing the frequency thereof.

Consequently, timing in which image writing is started is set to the same timing as in the case of the laser B in the part (4) of FIG. 6, so that writing can be started at the same position where the laser B in the part (4) of FIG. 6 starts writing.

According to this method, since the image clock period in an area outside the image area is modulated, noise can be reduced more effectively.

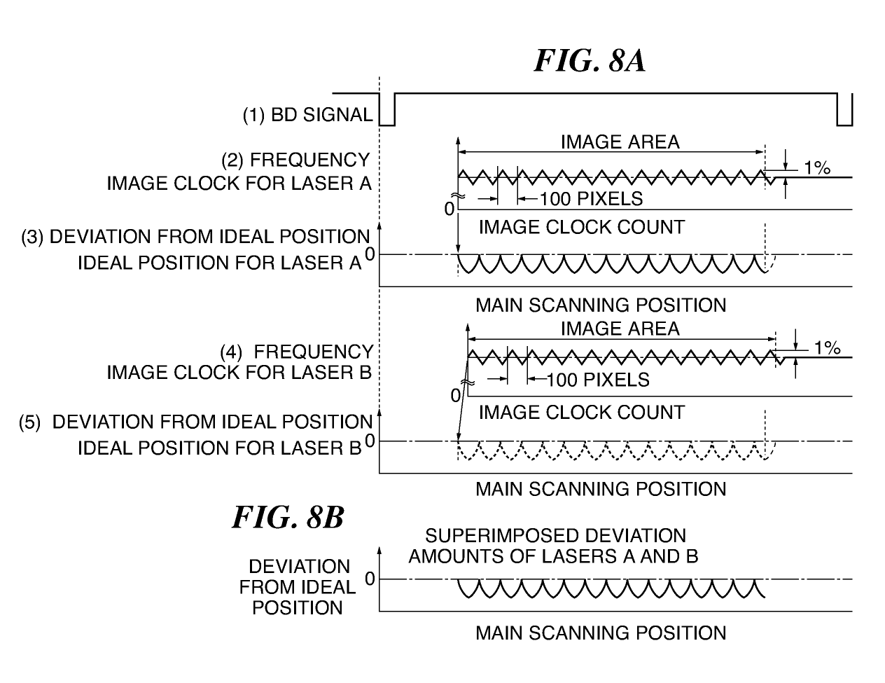

FIGS. 8A and 8B are diagrams useful in explaining a case where the frequency modulator in FIG. 2 is configured not to generate an image clock in timings in a area outside the image rear, i.e. before the image area is reached. In this case, noise is not generated during a time period over which generation of a clock is inhibited, and therefore it is possible to further enhance the noise-reducing effect.

Although in the present embodiment, the image clock modulation period is set to the same period at each image height in a single scanning operation, the image clock modulation period in a single scanning operation is not required to be constant so long as each of image clock modulation periods corresponding to respective image heights is identically set between image forming stations.

Thus, the present embodiment makes it possible to lower the peak level of noise generated by image clocks and provide an image free from dot deviation which occurs between multiple beams due to frequency modulation.

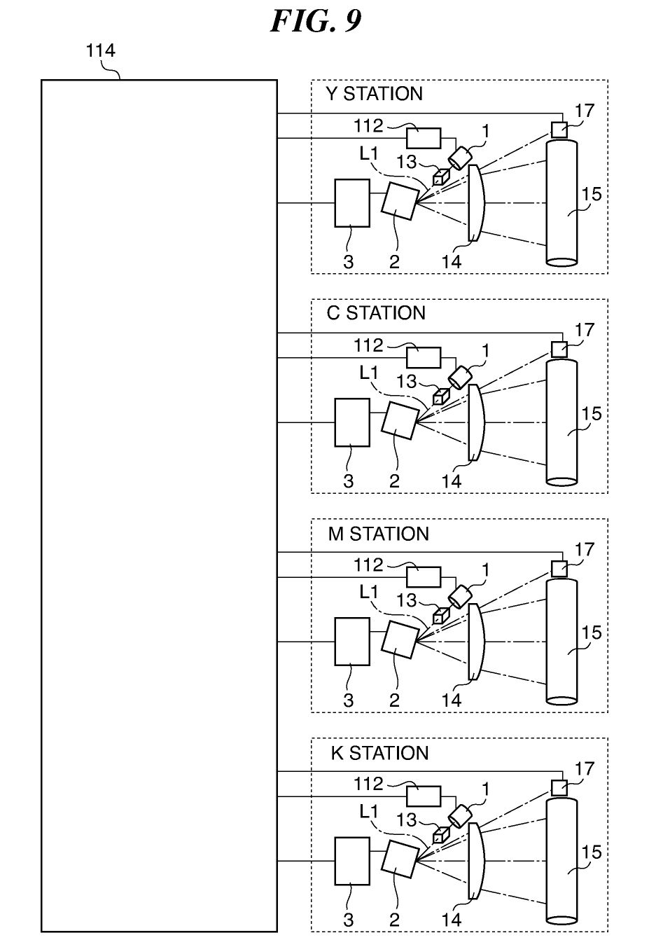

FIG. 9 is a schematic view of exposure units of an image forming apparatus, according to a second embodiment of the present embodiment.

The image forming apparatus including the exposure units shown in FIG. 9 is a tandem type.

As shown in FIG. 9, the image forming apparatus has four sections, i.e. Y, C, M, and K stations, each functioning as an image forming section (comprised of an exposure unit and a photosensitive drum 15). Each of the stations has the same construction as described in FIG. 1, and therefore description thereof is omitted.

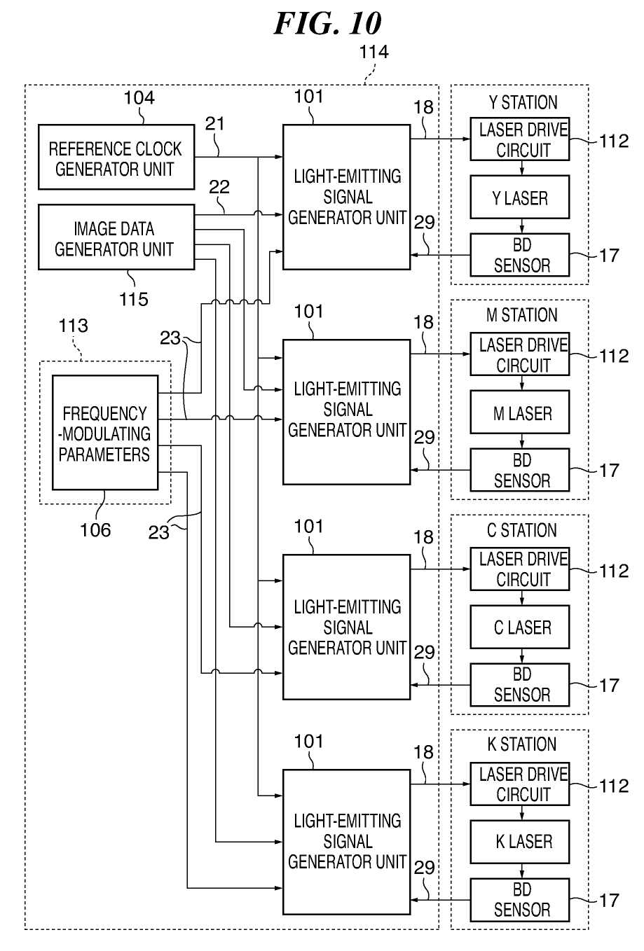

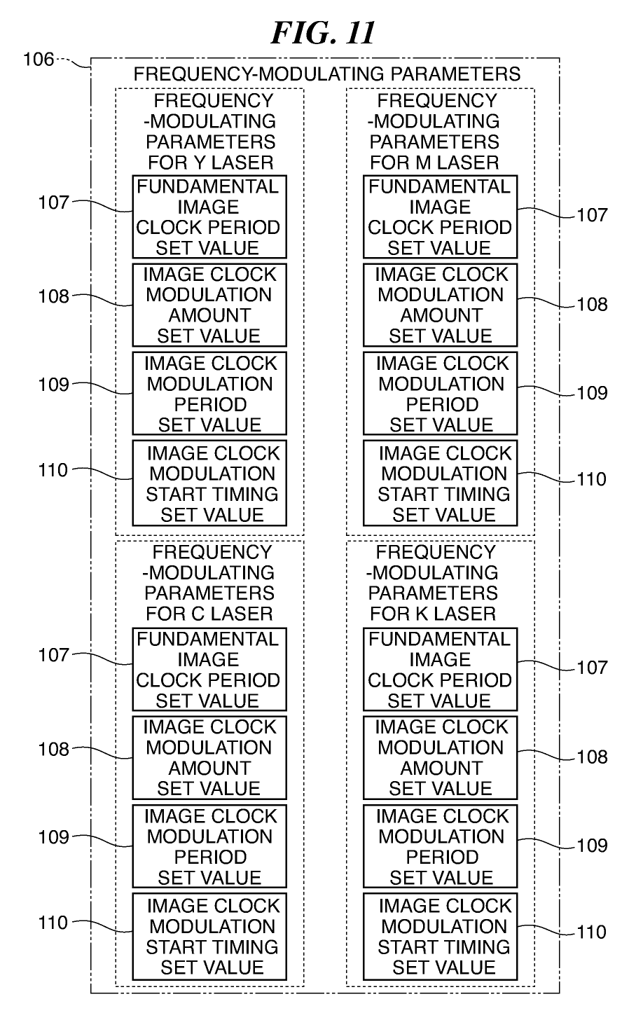

Next, the configuration of a frequency modulator for frequency-modulating each image clock to be used to drivingly control the associated laser light source 1 will be described with reference to FIGS. 10 and 11.

FIG. 10 is a block diagram of the frequency modulator according to the second embodiment, which is used to drivingly control the laser light source appearing in FIG. 9.

As shown in FIG. 10, the frequency modulator 114 for frequency-modulating image clocks to be used to drivingly control the respective laser light sources 1 is comprised of the reference clock generator unit 104 for generating the reference clock 21, the memory 113 for generating the frequency-modulating parameter signals 23, the image data generator unit 115 for generating the image data 22, and the light-emitting signal generator units 101.

The memory 113 stores the frequency-modulating parameters 106, and the frequency-modulating parameters 106 include various set values required for modulation of image clocks by the frequency modulator 114.

FIG. 11 is a block diagram showing the frequency-modulating parameters appearing in FIG. 10.

Specifically, as shown in FIG. 11, the fundamental image clock period set value 107 is stored in association with each of Y, M, C, and K lasers of the respective Y, M, C, and K stations, as a set value corresponding to the fundamental period of an image clock generally determined based on the drum surface-scanning speed of a laser and the resolution.

The image clock modulation amount set value 108 is stored in association with each of the Y, M, C, and K lasers, as a set value corresponding to a maximum amount of extension/shortening of an image clock from its fundamental period (i.e. corresponding to the fluctuation amount of the image clock).

The image clock modulation period set value 109 is stored in association with each of the Y, M, C, and K lasers, as a set value for setting the number of pixels required for the image clock period to start to be modulated from the fundamental period, reach the maximum period and the minimum period, and then return to the fundamental period.

The image clock modulation start timing set value 110 is stored in association with each of the Y, M, C, and K lasers, as a set value for setting timing for starting modulation according to an image clock modulation amount and an image clock modulation period after receiving the BD signal.

These set values are transferred to the light-emitting signal generator units 101 by the respective frequency-modulating parameter signals 23. As shown in FIG. 10, the image data generator unit 115 generates the image data 22 as a signal for controlling the laser light source 1 of each of the Y, M, C, and K stations to turn on for image formation. The image data 22 corresponding to the associated one of the laser light sources 1 is delivered to the associated light-emitting signal generator unit 101. The image data 22 is stored in the shift register 116 in the light-emitting signal generator unit 101.

The configuration of the light-emitting signal generator unit 101 is the same as that in the first embodiment, described with reference to FIG. 4, and therefore description thereof is omitted.

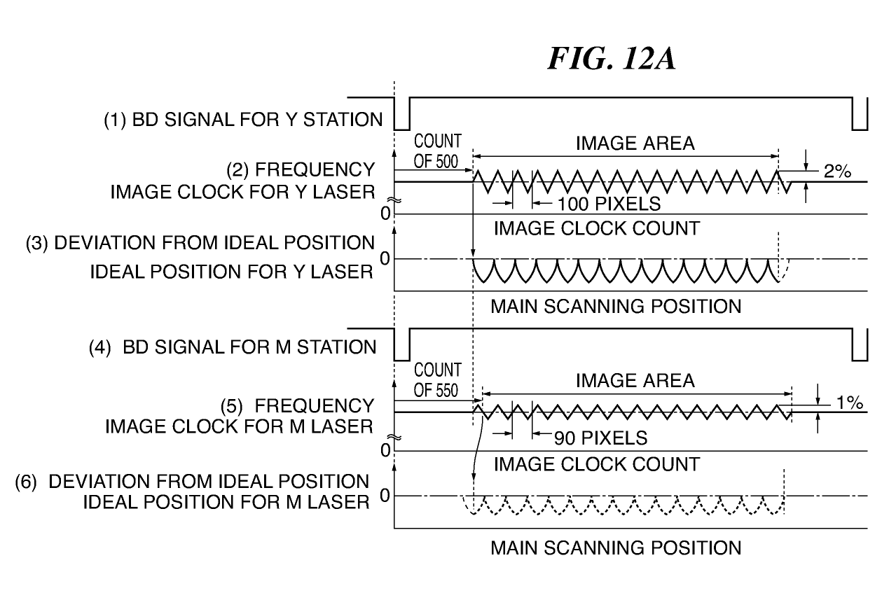

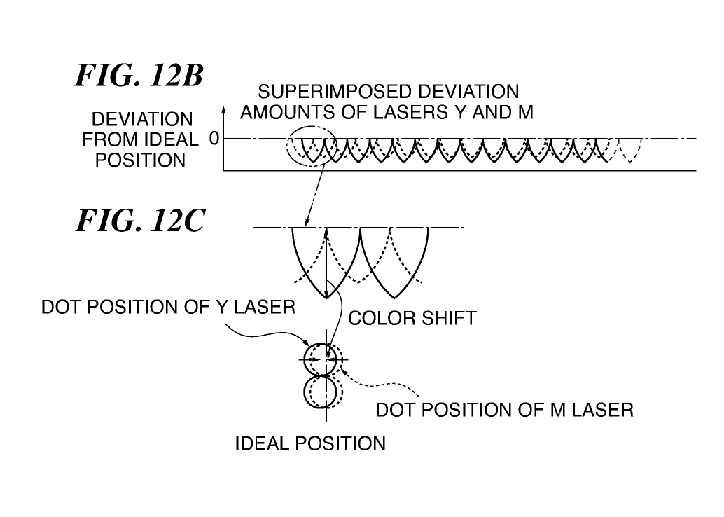

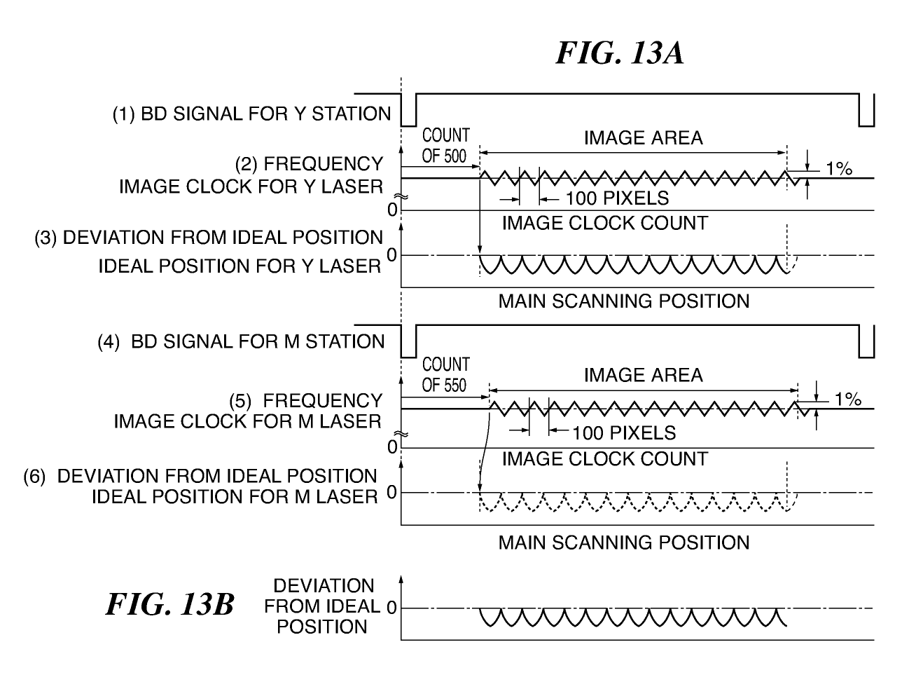

Next, image clock modulation realized by the above-described configuration for frequency modulation will be described with reference to FIGS. 12A to 12C, and 13A and 13B. FIGS. 12A to 12C, and 13A and 13B are diagrams useful in explaining the relationships between the frequencies of the respective image clocks generated by the frequency modulator and the main scanning position.

FIG. 12A is a diagram showing a case where the modulation period, the modulation amount, and the modulation start timing associated with the laser light source of the Y station and those associated with the laser light source of the M station are modulated separately.

A part (1) of FIG. 12A shows the BD signal 29, and in the part (1), there is shown a time period from a time point of detection of a BD signal pulse to a time point of detection of a next BD signal pulse, i.e. timing for one scanning operation performed by the Y laser on the drum surface.

A part (2) of FIG. 12A shows how the frequency of the image clock associated with the Y-station laser light source changes during the single scanning operation. The vertical axis represents the frequency of the image clock, and the horizontal axis represents the count of image clock pulses. The part (2) of FIG. 12A shows that counting is performs using the same frequency until a count of 500 is reached after detection of the BD signal, and from a count of 501, counting is performed with a cycle (period) of 100 counts while changing the frequency by a fixed fluctuation amount of +2%. Image writing is started in timing synchronous with a count of 501.

A part (3) of FIG. 12A is a diagram showing the amount of deviation of each dot from an ideal position on the drum surface in a case where the laser is driven at the image clock frequency shown in the part (2) of FIG. 5A. The vertical axis represents the deviation amount, and the horizontal axis represents the main scanning position on the drum surface.

Normally, an exposure unit of the image forming apparatus has an optical system thereof designed such that a laser beam scans the drum surface at a constant speed. In the present embodiment as well, it is assumed that the optical system of each exposure unit is designed such that a laser beam scans the drum surface at a constant speed.

In this case, when the frequency of an image clock is constant, intervals between dots become uniform. Image data for which the laser is driven is generated with equal dot intervals, so that when the frequency of the image clock is changed as in the present embodiment, each dot is formed at a location deviated from the ideal position.

This deviation amount is shown as “deviation from ideal position” in the part (3) of FIG. 12A. As the frequency is higher, the dot interval becomes smaller, and therefore the amount of deviation from an ideal position varies in a negative direction. On the contrary, as the frequency is smaller, the dot interval becomes larger, and therefore the amount of deviation from an ideal position varies in a positive direction. This relationship is shown in the parts (2) and (3) of FIG. 12A.

A part (4) of FIG. 12A shows the BD signal 29, and in the part (4), there is shown a time period from a time point of detection of a BD signal pulse to a time point of detection of a next BD signal pulse, i.e. timing for one scanning operation performed by the M laser on the drum surface.

Similarly to the part (2) of FIG. 12A, a part (5) of FIG. 12A shows how the frequency of the image clock associated with the M laser changes. The frequency of the image clock starts to be changed in timing synchronous with a count of the 501, as in the case of the Y laser. However, the leading end of an image corresponds to a count of 551. Differently from the modulation amount and modulation period associated with the Y laser, the modulation amount associated with the M laser falls within a range of ±1%, and one modulation period associated with the M laser corresponds to 90 counts.

Similarly to the part (3) of FIG. 12A, a part (6) of FIG. 12A shows the amount of deviation of each dot formed by the M laser from the ideal position on the drum surface.

FIG. 12B is a diagram showing the part (3) of FIG. 12A and the part (6) of the same in a superimposed manner.

In the tandem-type system, time from the detection of the BD signal to the start of writing varies from unit to unit, e.g. depending on mounting error between the exposure units or between the BD sensors 17. Therefore, by changing the image writing start timings associated with the respective Y and M lasers to timings shown in the part (2) of FIG. 12A and in a part (5) of FIG. 13A, respectively, it is possible to align an image formed by the Y station and one formed by the M station, on the drum surface.

However, when the Y laser and the M laser are different in the modulation amount, the modulation period, and the image clock modulation timing as shown in the part (2) of FIG. 12A and the part (5) of FIG. 13A, the amount of deviation from the ideal position varies from station to station, depending on an image height, as shown in FIG. 12B. This causes color shift or the like, which adversely affects the image.

FIGS. 13A and 13B are diagrams useful in explaining a case where the image clock modulation start timing is changed in accordance with the image writing start timing to thereby adjust the modulation period and the modulation amount between the lasers of the respective stations.

In FIG. 13A, the image clock modulation start timing associated with the M laser is delayed by the number of clocks corresponding to the number of the delayed clocks of the image writing start timing to start modulation. In this case, the Y laser and the M laser are both configured to have a modulation period of 100 clocks and a modulation amount of ±1%.

Further, the difference in the modulation amount between adjacent pixels is 1%÷25 (clocks)=0.04%. In this case, as shown in FIG. 13B, the amounts of deviation of the respective Y-station and M-station images from the ideal position become equal to each other at each image height.

In this case, the amounts of deviation of the images formed by the respective stations from the ideal position become equal to each other at each image height in the main scanning direction, as shown in FIGS. 13A and 13B, so that occurrence of color shift between the images formed by the respective stations can be prevented.

Noise can be reduced more effectively by controlling the writing start timing by modulating the image clock before the image area is reached. Further, the noise-reducing effect can be even further improved by inhibiting generation of image clocks in timings corresponding to an area outside the image area.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures and functions.

This application claims priority from Japanese Patent Application No. 2006-280146 filed Oct. 13, 2006, which is hereby incorporated by reference herein in its entirety.

What is claimed is:

1. A frequency modulator for frequency-modulating an image clock, comprising:
a modulated image clock-generating unit configured to generate frequency-modulated image clocks; and
a frequency change profile control unit configured to control frequency change profiles of the respective frequency-modulated image clocks such that the frequency change profiles become identical with respect to positions of associated images formed by respective lasers.

2. A frequency modulator configured to generate image clocks having frequencies which are different between at least one portion and another portion of a main scanning line on an image carrier which is scanned by laser beams emitted from a plurality of semiconductor lasers, irrespective of a magnification of an image, comprising:
a modulation start timing-setting unit configured to set modulation start timing in which modulation of each image clock is to be started;
a modulation period-setting unit configured to set a repetition period over which the image clock is modulated;
a modulation amount-setting unit configured to set an amount of modulation by which the image clock is modulated from a reference period thereof;
a modulated image clock-generating unit configured to generate a modulated image clock by modulating a frequency of each of the image clocks into a frequency set by said modulation start timing-setting unit, said modulation period-setting unit, and said modulation amount-setting unit; and
a frequency change profile control unit configured to control frequency change profiles of the respective modulated image clocks such that the frequency change profiles become identical with respect to positions of associated images formed by respective lasers.

3. A frequency modulator as claimed in claim 2, wherein the modulation start timing which is set by said modulation start timing-setting unit is defined by a count of said modulated image clock.

4. A frequency modulator as claimed in claim 2, wherein the modulation start timing which is set by said modulation start timing-setting unit is controlled by modulating a repetition period of the modulated image clock in timings corresponding to an area outside an image area.

5. A frequency modulator as claimed in claim 2, wherein the modulation start timing which is set by said modulation start timing-setting unit is controlled by changing output start timing of the modulated image clock in a main scanning direction.

6. A frequency modulator as claimed in claim 2, wherein the modulation period which is set by said modulation period-setting unit is defined by a count of the modulated image clock.

7. A frequency modulator as claimed in claim 2, wherein the modulation amount which is set by said modulation amount-setting unit is defined by a proportion with respect to a reference period of the image clock.
